(19) United States
(12) Patent Application Publication
(10) Pub. No.: US 2002/0150822 A1
(43) Pub. Date: Oct. 17, 2002

(54) Lightweight composite grid for battery plates

(76) Inventors: John V. Marlow, Oakville (CA); Jack Sklarchuk, Burlington (CA); Albert M. Vincze, Oakville (CA)

Correspondence Address: Arne I. Fors, Gowling Lafleur Henderson LLP, Suite 4900, Commerce Court West, Toronto, ON, M5L 1J3, CA

(21) Appl. No.: 09/773,582

(22) Filed: Feb. 2, 2001

(51) Int. Cl. H01M 4/74; B23P 13/00

(52) U.S. Cl. 429/241; 429/234; 29/2

(57) ABSTRACT

A reduced weight lead-acid battery is produced incorporating light-weight negative battery plates each comprising an electrically-conductive open mesh grid formed from a strip of expanded, punched or cast metal, a pair of outer lower density support layers such as polymer or polymer-coated glass fibre or low density metal on each side of the central open grid, preferably arranged in a rectangular lattice, attached to each other through openings in the grid preferably by an acid-resistant adhesive, and an electrochemically-active paste saturating the void spaces thereof. An acid-resistant thermoplastic resin adhesive or ties or lugs may be used to attach the support layers together.

### BACKGROUND OF THE INVENTION

(i) Field of the Invention

This invention relates to lightweight battery plates and, more particularly, relates to lightweight laminated negative battery plates for use in lead-acid batteries.

(ii) Description of the Related Art

Conventional lead-acid batteries comprise a plurality of alternating positive and negative battery plates stacked in a suitable case. Each plate normally consists of an electrically-conductive open-mesh grid typically made of lead or a lead alloy with the open-mesh grid filled with an electrochemically-active paste. The open-mesh grid is self-supporting and accordingly must consist of sufficient metal or metal alloy to not only conduct electricity but also to carry the weight of the grid and the paste and to provide sufficient strength for processing and handling during manufacture.

Extensive research effort has been undertaken to examine the bonding of polymer materials directly to lead and lead alloy mesh materials to reduce the amount of lead or lead alloy in the negative grids to reduce the weight of batteries and to reduce lead consumption while maintaining battery performance. Although battery plates using the lead/polymer concept have demonstrated satisfactory battery performance, all efforts to apply the concept to a sustained commercial process have failed due to numerous production and material compatibility problems. Original equipment auto makers continuously, and now more emphatically, demand lighter batteries in response to higher fuel efficiency requirements under the corporate average fuel efficiency (CAFE) regulations.

U.S. Pat. No. 4,118,553 granted Oct. 3, 1978 to Globe-Union, Inc. discloses a composite die-cast battery grid having a rectangular peripheral injection-molded plastic support for an electrically-conductive terminal lug with a plurality of divergent conductive runners extending therefrom.

U.S. Pat. 4,221,854 granted Sep. 9,1980 and Divisional Patent 4,286,362 granted Sept 1, 1981 to General Motors Corporation disclose a lightweight grid having a laminated reticulated open-mesh portion, the laminated portion consisting of a support layer of a plastic material adhesively bonded to an electrically-conductive foil layer formed by concurrently expanding a laminated grid by an expanded metal process.

U.S. Pat. No. 3,973,991 granted Aug. 10, 1976 to NL Industries, Inc. discloses a three plie laminated electrode having a perforated centre plie of an electrically-conductive sheet and two outer plies coextensive therewith of a porous, compressed and sintered composite of synthetic fibres and lead oxide powder.

The demands for more fuel efficient cars will soon see the introduction of the 36 V starter battery producing 7-8 kilowatts of power, compared to the current 12 V, 3-3.5 kilowatt system. Battery weight will correspondingly increase. The lightweight negative grid to be described herein will reduce the weight of a 12 V battery by about 1.4 pounds, and the weight of a 36 V battery by about 2.8 pounds. Reductions of this magnitude are considered to be very significant by the automakers. The same weight reduction potential enhances the practicality of hybrid/internal combustion engine power plants that are now being commercialized.

It is a principal object of the present invention therefor to provide a negative battery plate which is simple in construction and assembly and light in weight while maintaining the reliable performance of a negative plate of conventional lead-acid batteries.

It is a further object of the invention to provide a negative battery plate incorporating lightweight non-metallic components therein such as lightweight polymers or polymer-coated glass fibre as reinforcement substituted for heavy metal that they replace at economic production rates and at lower cost than the cost of conventional battery plates.

### SUMMARY OF THE INVENTION

In its broad aspect, the lightweight negative battery grid of the present invention comprises a central, electrically-conductive open grid formed from a strip of expanded metal, punched metal strip or cast metal and a pair of light-weight metallic or non-metallic outer support layers coextensive with said central, electrically-conductive grid and positioned on each side of said central, electrically-conductive grid. The pair of non-metallic outer support layers preferably comprise polymer fibre or polymer-coated glass fibre lattices attached such as by adhesive bonding to each other through openings in the central, electrically-conductive grid. The polymer-coated glass fibre grid comprises one or more glass fibres which optionally may have an acid-resistant polymer coating such as a coating of polyvinyl chloride, polypropylene or polyethylene to keep the fibres from unravelling. Preferably, the polymer fibres and polymer-coated glass fibre mesh layers are coated on abutting sides with an acid-resistant adhesive and attached to each other by the acid-resistant adhesive. Optionally, the mesh layers are attached to each other by thermal bonding of acid-resistant thermoplastic fibres or thermoplastic-coated glass fibres, or by mechanical connectors such as ties or tabs. The central, electrically-conductive open grid is an expanded, punched or cast lead or lead alloy having an enlarged diamond shape to minimize grid weight but not to reduce weight so as to adversely effect the battery performance. Excess negative grid metal normally present for mechanical strength is replaced by a pair of non-metallic outer support layers. The volume of metal removed is replaced by an equal volume of polymer, polymer-coated glass fibre or light-weight metal or the like lightweight material such that the amount of electrochemically-active paste remains unchanged. Typically, by way of example, 1.4 cc of metal per grid can be removed and replaced by 1.4 cc of the lighter polymer per grid. A negative battery plate of the invention for use in a lead-acid battery comprises the lightweight, negative battery grid additionally having an electrochemically-active paste saturating the negative battery grid.

A lightweight lead-acid battery of the invention comprises a closed casing, a plurality of alternating positive and negative battery plates stacked in said casing, a positive terminal and a negative terminal connected to respective positive and negative battery plates and extending through the casing, each negative battery plate comprising a battery grid having a central, electrically-conductive open grid having an enlarged repeating diamond shape and a pair of outer support layers coextensive with said central, electrically-conductive grid and positioned on each side of said central, electrically-conductive grid, said pair of outer support layers comprised of a polymer fibre or polymer-coated glass fibre lattices or light-weight metal lattices attached preferably by bonding to each other by an acid-resistant adhesive through openings in the central, electrically-conductive grid.

In its broad aspect, the method of the invention for producing a lightweight, negative battery grid comprises expanding, punching or casting a lead or lead alloy strip to form a continuous, lead or lead alloy open grid having opposite sides, feeding a layer of polymer fibre or polymer-coated glass fibre mesh, carbon fibre mesh or light-weight metal wire mesh preferably having an acid-resistant adhesive coated thereon adj acent each opposite side of the continuous lead or lead alloy open grid, and passing said continuous lead or lead alloy open grid with the layer of polymer fibre or polymer-coated glass fibre mesh, carbon fibre mesh or light-weight metal wire mesh having the acid-resistant adhesive coated thereon on each side thereof through a pair of opposed pinch rolls for compression of the layers of the polymer fibre or polymer-coated glass fibre mesh, carbon fibre mesh or light-weight metal wire mesh onto the continuous lead or lead alloy open grid whereby the layers of polymer fibre or polymer-coated glass fibre mesh, carbon fibre mesh or light-weight metal wire mesh are attached by adhesive bonding to each other through openings in the lead or lead alloy open mesh. The method additionally comprises passing the lightweight, negative battery grid through a pasting stage for depositing an electrochemically-active paste thereon.

### BRIEF DESCRIPTION OF THE DRAWING

The battery plate of the present invention and its method of production will now be discussed with reference to the accompanying drawings, in which:

FIG. 1 is a plan view of the negative battery grid of the invention;

FIG. 2 is a schematic illustration of the method of the invention; and

FIG. 3 is a perspective view, partly cut away, of a battery having the battery plates of the invention.

### DESCRIPTION OF THE PREFFERED EMBODIMENT

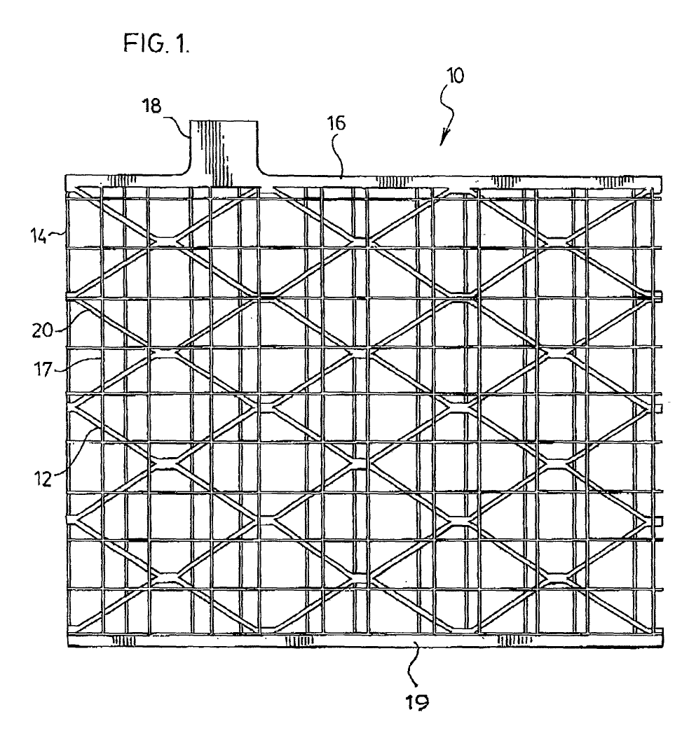

With reference to FIG. 1, an embodiment of lightweight negative battery grid 10 of the present invention is shown comprising a lead or lead alloy central expanded grid 12 surrounded on each side by outer support layers 14, 15 consisting of battery-acid resistant polymer fibres or glass fibres coated with a layer of a battery-acid resistant polymer typified by way of example by polyvinylchloride, polypropylene, polyethylene or the like. Grid 12 has a top frame bar 16 and lug 18 integral with grid wires 20 expanded into a repeating diamond shape. Lead or lead alloy grid 12 preferably is formed by expanding lead or lead alloy strip but may comprise punched lead or lead alloy strip or cast lead or lead alloy strip. Co-extensive with grid 12 are the outer support layers 14, 15 of polymer fibre or polymer-coated glass fibre. A rectangular lattice is shown but a circular, triangular, hexagonal, rhomboidal or the like repeating lattice may be utilized for reinforcement. Mesh grid 20 has a weight of approximately 10 gms/grid, excluding the top 16 and bottom×frames and lug 18, while maintaining conventional negative plate thickness formid-size SLI (starting, lighting, ignition) batteries. Although the description will proceed with reference to polymer fibres and polymer-coated glass fibres, it will be understood that acid resistant non-metallic fibres such as carbon fibre and light-weight metal wire such as extruded aluminum alloy are contemplated.

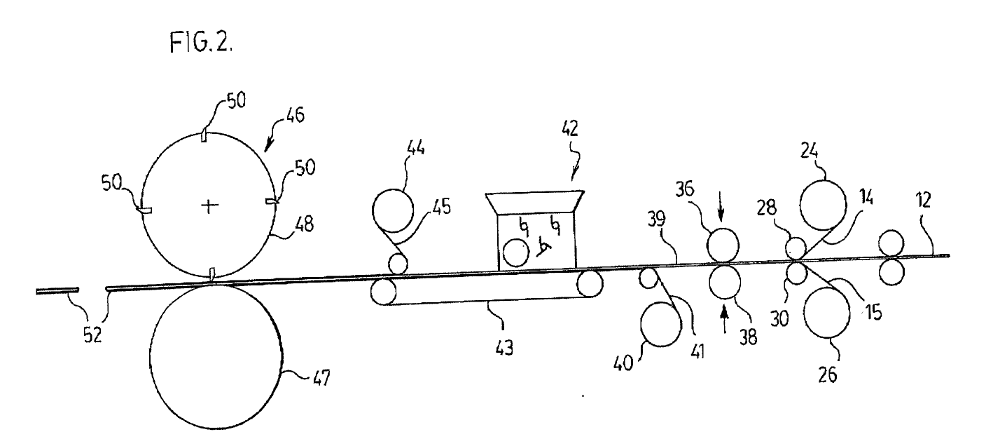

Turning to FIG. 2, the method of the invention is illustrated schematically to comprise a continuous strip of expanded lead or lead alloy grid 12 covered on each side by a continuous strip layer of polymer fibre or polymer-coated glass fibre 14, 15 fed as a rectangular lattice from rolls 24,26 respectively. Fibre mesh 14, 15 pass between opposed collector rolls 28, 30 in order to abut opposite sides of expanded metal strip 12, and then pass between opposed compression rolls 36,38 for compression of the layers 14, 15 onto the opposite sides of metal strip 12 and against each other through the openings of the expanded lead or lead alloy grid for bonding of the layers 14, 15 together.

A contact cement for attachment of the layers 14, 15 together preferably is pre-applied to the polymer fibres or polymer-coated glass fibres.

Alternatively, a thermoplastic resin adhesive or a hydrocarbon-based hot melt adhesive may be used with an appropriate heating system, or a system of ties or tabs used to mechanically attach the layers 14, 15 together. A thermally-sensitive adhesive would be quickly heated by infra-red heaters, not shown, to a temperature above the melting point of the adhesive but below the melting point of the polymer coating, immediately before passage between compression rolls 36, 38.

The resulting composite strip 39 having a central open metal grid and outer layers of polymer fibres or polymer-coated glass fibres bonded together passes over paper roll 40 to receive bottom layer of paper 41 and then under paster hopper 42 while supported by endless belt conveyor 43. Electrochemically-active paste is applied to the composite strip to saturate the voids in the open grid and the fibre layers. The pasted strip passes under paper roll 44 to receive top layer of paper 45 and the saturated composite strip having top and bottom paper layers is advanced to a plate cutter 46 having an anvil roll 47 opposed to a mating die roll 48 having angularly equispaced transverse die cutters 50 for severing battery plates 52 from the pasted composite strip.

The resulting battery plates having a central, electrically-conductive open grid formed of expanded metal such as lead or lead alloy and a pair of outer support layers of polymer fibres or polymer-coated glass fibre coextensive with and clamped to said central grid and to each other has structural integrity and strength which permits a substantial increase in the size of the diamonds of the electrically-conductive open metal grid for significant savings in metal costs and weight while having the ability to retain the electrochemically-active paste.

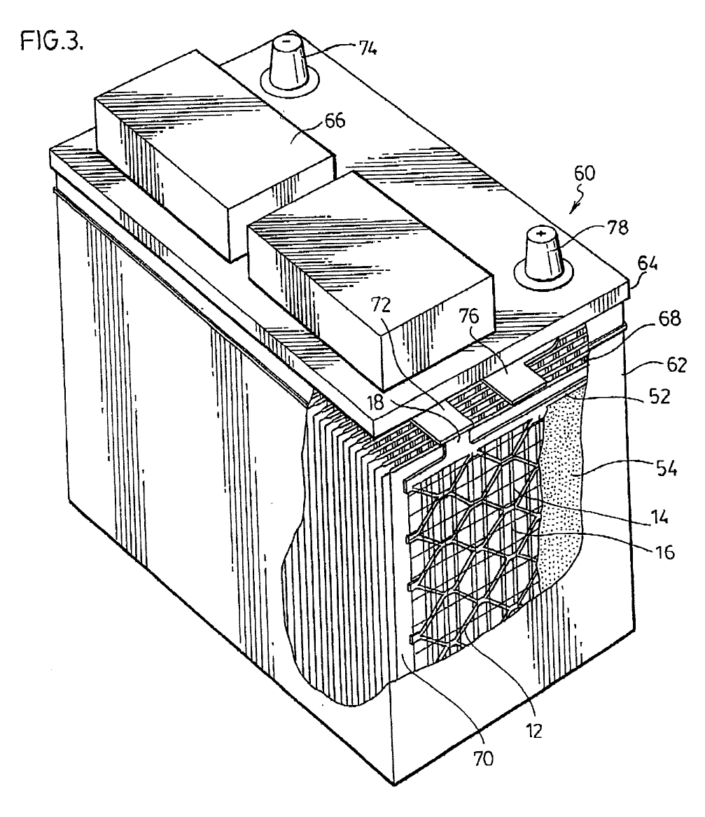

With reference now to FIG. 3, a battery 60 having a plastic casing 62 with cover 64 including vent covers 66 contains the negative battery electrode plates 52 produced by the method of the invention. The negative plates 52 including paste 54 are stacked vertically alternating with positive plates 68 separated from one another by plate separators 70. The grid lugs 18 of negative plates 52 are interconnected by metal strap 72 to negative battery post 74 and the grid lugs, not shown, of positive plates 68 are interconnected by metal strap 76 and intercell connectors, not shown, to positive battery post 78. Sulphuric acid solution, not shown, is added in an amount to submerge the battery plates for operating the battery.

The battery plate of the invention will now be discussed with reference to the following non-limitative examples.

Seven sets of tests were run on batteries that contained cells with control negative plates (similar to plates used in the battery industry) and lead-polymer (light weight) hybrid negative plates with the use of an adhesive according to the present invention. The test batteries were subjected to the following electrochemial tests:

| | |
|---|---|
| Formation | the cell and negative electrode voltages of the control and |
| Tests: | hybrid plates were compared (current was adjusted to input |
| | 150-200% of theoretical capacity in 24 hours). |
| Reserve | the control and hybrid negative plate cells were cycled at |
| Capacity: | a discharge rate of 4A/plate to 1.75 V and charged at |
| | 3A/plate to 2.6-2.7 V (industry standard test) to determine |
| | the capacity of the plates and to compare the control and |
| | hybrid plate cell and electrode voltages. |
| Cold | the control and hybrid plate cells were cooled to −18° C. and |
| Cranking | currents of up to 90A/plate (550A to 650A/battery, |
| Tests: | depending on number of negative plates/cell, industry |
| | standard test) were applied to compare the cell and |
| | electrode voltages of the control and hybrid plates. |
| Load | current from 4A to 90A per plate were applied to the |
| Tests: | control and hybrid plates, at room temperature, to compare |
| | the cell and electrode voltages. |
| Cycle | selected control and hybrid negative plates were subjected |
| Tests: | to continuous cycling tests under the reserve capacity |
| | regime. |
| Hot J240 | selected control and hybrid negative plates were subjected |
| Tests: | to a cycling regime, 75° C., that consisted of a discharge for |
| | 4 minutes at 6A/plate and a charge for 10 minutes, at 6A |
| | per plate, to 14.8 V (typical of industry standard tests). |

Three examples in which control and lead-hybrid batteries were subjected to some of the above tests follow.

### EXAMPLE 1

A battery that contained 2 cells with control negatives (fabricated in-house) and 4 cells with lead-hybrid negatives were tested and compared to a commercial control battery. All in-house controls and lead-hybrid cells contained three negative plates per cell. Four electrochemical tests were performed.

| | |
|---|---|
| Formation: | 5A/cell for 28 hours (115 Ah in) |
| | No difference in formation voltages between |
| | in-house controls and lead-hybrid cells. No |
| | data was available for the commercial control. |
| Reserve Capacity Test: | 4A/plate. The negative plate voltages are |
| | shown |

| Test | Control | Lead-Hybrid | Commercial Control |
|---|---|---|---|
| Neg. | −0.93 to −0.88 V | −0.93 to −0.88 V | −0.91 to −0.83 V |

As shown, the negative plates (with lead-hybrid grids) performed as well as did the in-house controls and better than the commercial-control negative plates.

Typical Load Test: 43A/plate at room temperature. The battery
and negative plate voltages are shown.

| Test | Control | Lead-Hybrid | Commercial Control |
|---|---|---|---|
| Battery | 10.5 V/battery | 10.5 V/battery | 10.9 V/battery |
| Negative | −0.84/negative | −0.84 V/negative | −0.82 V/negative |

The battery voltages of the in-house control and the lead-hybrid battery were slightly lower than the voltage of the commercial control, suggesting weaker positives in the in-house and lead-hybrid batteries, because the negatives in the in-house and lead-hybrid batteries performed better than the negatives in the commercial control.

CCATest: 85A/plate for 30 seconds at-18° C. The battery and negative plate voltages are shown.

| Test | Control | Lead-Hybrid | Commercial Control |
|---|---|---|---|
| Battery | 7.1 V/battery | 7.1 V/battery | 7.8 V/battery |
| Negative | −0.65 to | −0.6 to | −0.5 to |
| | −0.45 V/neg | −0.4 V/neg | −0.4 V/neg |

Note:
The voltages shown are averages of about 2 to 3 replicate tests. The in-house and lead-hybrid voltages were similar and lower than the commercial control, as described above. The lead-hybrid negative-plate voltage was slightly lower than that of the in-house control, but, higher than that of the commercial control.

### EXAMPLE 2

The battery shown in Example 1 was then subjected to a hot J240 test. Cycling data is shown below.

Hot J240 Cycling (75° C.)

| | Commercial Control | | | Polymer (lead-hybrid) | | | | In-house Control | |
|---|---|---|---|---|---|---|---|---|---|
| | Battery | Cell | Neg. | V38 | | R47 | | Cell | Neg |
| Cycle | V | V | V | Cell | Neg. | Cell | Neg | V | V |
| 432 | 7.8 | | −0.45 | | −0.638 | | −0.600 | | −0.71 |
| 862 | | | | 1.3 | | 1.3 | | 1.5 | |
| 1282 | 9.53 | | −0.4 | 1.5 | −0.6 | 1.2 | −0.47 | 1.5 | −0.6 |
| 1722 | | | | 1.28 | −0.47 | 1.22 | −0.47 | 1.55 | −0.76 |
| 2150 | 9.4 | | −0.44 | 1.5 | −0.8 | Rev | −0.75 | 0.4 | −0.8 |
| 2573 | | | | 1.37 | −0.63 | 1.2 | −0.28 | 1.65 | −0.69 |
| 3012 | | | | | −0.5 | | 0 | | −0.8 |
| 3570 | 9.65 | | −0.51 | 1.85 | −0.75 | 1.84 | −0.78 | 1.85 | −0.76 |
| 4019 | | | | 1.44 | −0.61 | Rev | −0.68 | 1.46 | −0.68 |
| | | | | 1.53 | −0.52 | 0.2 | −0.54 | 1.43 | −0.63 |
| 4531 | 9.21 | | −0.373 | 0.33 | −0.633 | 0.45 | −0.575 | 1.18 | −0.66 |
| | | | | 1.5 | −0.606 | 1.05 | −0.270 | 1.38 | −0.520 |

Cycling terminated - 4 of 6 cells below 1.2 V - due to failed positives
Hot J240 cycling regime: 4-minute discharge at 6A/plate
10 minute charge at 6V/plate
75° C.

| Load | | | | | | |
|---|---|---|---|---|---|---|
| A/plate, | | | Polymer | | | |
| 30s | Commercial Control | | (Lead-Hybrid) | | In-house Control | |
| Volts | Battery | Negative | Battery | Negative | Battery | Negative |
| 85 | 9.5 | −0.61 | 8.9 | −0.6 | 8.4 | −0.6 |
| 43 | 10.9 | −0.82 | 12.0 | −0.90 | 12.0 | −0.90 |
| 17 | 12.7 | −0.92 | 12.5 | −0.95 | 12.5 | −0.95 |

In the above test, battery voltages were not measured for the in-house and the lead-hybrid battery, since a battery was a combination of control and hybrid cells. The above table shows that, generally, the polymer (hybrid) negative electrode potential is lower than the control, but, in all cases, the polymer negative electrode potential is higher than the industry-standard commercial-control battery negative electrodes.

### EXAMPLE 3

A battery fabricated as above was subjected to a series of load tests at room temperature. Selected data are shown below.

The above data show that in all cases, the in-house control and the lead-hybrid negative plate voltages were similar and, except in the 85A/plate test, performed better than did the commercial controls. In the 85A/plate test, all negative plate voltages were equivalent.

It will be understood, of course, that modifications can be made in the embodiments of the invention described herein without departing from the scope and purview of the invention as defined by the appended claims.

1. A lightweight, negative battery grid having a central, electrically-conductive open grid and a pair of outer support layers coextensive with said central, electrically-conductive grid and positioned on each side of said central, electrically-conductive grid, said pair of outer support layers attached to each other through openings in the central, electrically-conductive grid.

2. A lightweight, negative battery grid as claimed in claim 1, in which each of the outer support layers comprises at least one fibre of a non-metallic material or wire of a light-weight metallic material selected from the group consisting of a polymer fibre, polymer-coated glass fibre, carbon fibre and light-weight metal wire.

3. A lightweight, negative battery grid as claimed in claim 1, in which each of the outer support layers comprises a plurality of fibres of a polymer or a polymer-coated glass fibre.

4. A lightweight, negative battery grid as claimed in claim 3, in which the fibres of polymer or polymer-coated glass fibre are disposed longitudinally and transversely of the strip of expanded metal to form a lattice.

5. A lightweight, negative battery grid as claimed in claim 3, in which the fibres of polymer or polymer-coated glass fibres form rectangular, hexagonal, circular, triangular or rhomboidal lattices.

6. A lightweight, negative battery grid as claimed in claim 4, in which the polymer-coated glass fibre lattice is comprised of glass fibres having a coating of an acid-resistant polymer of polyvinylchloride, polypropylene or polyethylene coating to keep the fibres from unravelling.

7. A lightweight, negative battery grid as claimed in claim 6, in which the polymer-coated glass fibre support layers are attached to each other by an acid-resistant adhesive.

8. A lightweight, negative battery grid as claim in claim 4, in which the fibres of polymer of the outer support layers are attached to each other by a thermoplastic resin adhesive or by ties or lugs.

9. A negative battery plate for use in a lead-acid battery comprising a lightweight, negative battery grid as claimed in claim 7 having a central, electrically-conductive grid formed of lead or lead alloy and an electrochemically-active paste saturating the negative battery grid.

10. A negative battery plate for use in a lead-acid battery as claimed in claim 9, in which the central, electrically-conductive open grid is formed from a strip of expanded lead or lead alloy, punched strip of lead or lead alloy or cast lead or lead alloy.

11. A lead-acid battery comprising a closed casing, a plurality of alternating positive and negative battery plates stacked in said casing, a positive terminal and a negative terminal connected to respective positive and negative battery plates and extending through the casing, each negative battery plate comprising a grid having a central, electrically-conductive open mesh formed from a strip of expanded, punched or cast lead or lead alloy metal and a pair of outer support layers coextensive with said central, electrically-conductive grid and positioned on each side of said central, electrically-conductive grid, said pair of outer support layers each comprising at least one fibre of a light-weight metallic or a non-metallic material adhesively attached to each other through openings in the central, electrically-conductive grid, and an electrochemically-active paste saturating the battery plates.

12. A lead-acid battery as claimed in claim 11, in which each of the outer support layers comprises a plurality of fibres of a polymer or a polymer-coated glass fibre.

13. A lead-acid battery as claimed in claim 12, in which the fibres of polymer or polymer-coated glass fibre are disposed longitudinally and transversely of the strip of expanded metal to form a lattice.

14. A lead-acid battery as claimed in claim 13 in which the polymer-coated glass fibre is glass fibre having a polyvinylchloride, polypropylene or polyethylene coating.

15. A lead-acid battery as claimed in claim 14 in which the polymer-coated glass fibre layers form a rectangular lattice and are bonded to each other by an acid-resistant adhesive.

16. A negative battery grid as claimed in claim 1 in which the central, electrically-conductive open grid is an expanded lead or lead alloy having a diamond shape.

17. A negative battery grid as claimed in claim 16 in which the polymer-coated glass fibre grid is comprised of glass fibres having an acid-resistant polymer coating thereon and an acid-resistant adhesive coated on one side of the polymer-coated glass fibre grid.

18. A method of producing a lightweight, negative battery grid comprising expanding a lead or lead alloy strip to form a continuous, expanded, lead or lead alloy open grid having opposite sides, feeding a layer of a polymer fibre or a polymer-coated glass fibre having an adhesive coated thereon adjacent each side of the continuous, expanded, lead or lead alloy open grid, passing said continuous, expanded lead or lead alloy open grid with a layer of polymer fibre or a polymer-coated glass fibre grid having an acid-resistant adhesive coated thereon on each side thereof through a pair of opposed pinch rolls for compression of the layers of the polymer fibre or polymer-coated glass fibre onto the continuous, expanded lead or lead alloy open grid whereby the layers of polymer fibre or polymer-coated glass fibre adhesively attached to each other through the lead or lead alloy open grid.

19. A method as claimed in claim 16 comprising passing the lightweight, negative battery grid through a pasting stage for saturating an electrochemically-active paste thereon.
